(19) United States
(12) Patent Application Publication
(10) Pub. No.: US 2024/0302255 A1
(43) Pub. Date: Sep. 12, 2024

(54) APPLICATION OF METALLO-SUPRAMOLECULAR BRANCHED POLYMERS IN CRYO-ELECTRON MICROSCOPY SAMPLE PREPARATION

(71) Applicant: VERSITECH LIMITED, Hong Kong (CN)

(72) Inventors: Shangyu DANG, Hong Kong (CN); Yixin XU, Hong Kong (CN); Yufeng WANG, Hong Kong (CN); Lang WANG, Hong Kong (CN)

(21) Appl. No.: 18/568,727

(22) PCT Filed: Jun. 8, 2022
(86) PCT No.: PCT/CN2022/097629

§ 371 Date: Dec. 8, 2023

Related U.S. Application Data
(60) Provisional application No. 63/208,006, filed on Jun. 8, 2021.

(51) Int. Cl. G01N 1/42; G01N 23/225

(52) U.S. Cl. CPC G01N 1/42; G01N 23/225

(57) ABSTRACT

Disclosed are methods and compositions for use in preparing dynamic biological macromolecules for high-resolution cryo-electron microscopy or cryo-electron tomography imaging. The compositions contain a metallo-supramolecular branched polymer with a positive zeta potential, containing a hydrophilic polymer segment, a chelating chemical group, and a metal ion. The hydrophilic polymer segment is covalently bonded to the chelating chemical group that is in turn bonded to the metal ion via a dative bond. The methods and compositions can be used to improve particle distribution in vitreous ice and/or to change particle orientations in vitreous ice. Accordingly, the methods and compositions can be utilized to improve particle distribution for high resolution structure determination using single-particle cryo-EM.

### CROSS-REFERENCE TO RELATED APPLICATION

This application claims benefit of and priority to U.S. Provisional Application No. 63/208,006 filed Jun. 8, 2021, which is incorporated herein by reference in its entirety.

### FIELD OF THE INVENTION

The field of invention is generally related to imaging of samples (such as biological samples), particularly cryo-electron microscopy or cryo-electron tomography of biological samples with improved distribution of particles in their native conformations and/or reduction of particles at the air-water interface of thin films used in these imaging methods.

### BACKGROUND OF THE INVENTION

Visualization of biological macromolecules at atomic resolution provides valuable information for unravelling the fundamental mechanisms of many biological processes and also for driving the development of drugs for diseases caused by dysfunctional biological macromolecules. Recent technical breakthroughs in single-particle cryo-EM have powered a “resolution revolution” in structural biology by circumventing the major challenges faced when using traditional X-ray crystallography method (Wu and Lander, Biophys. J. 119, 1281-1289 (2020); Nakane, et al., Nature 587, 152-156 (2020); Yip, et al., Nature 587, 157-161 (2020); Cheng, Science 361 (6405), 876-880 (2018)). Despite these advances, there are still some recurring problems limiting the application of cryo-EM. Among these challenges, preparations of cryo-specimen that are suitable for high-resolution 3D reconstruction using single-particle cryo-EM is still a bottleneck in many cases, because vitrification of specimen is a delicate process (Passmore and Russo, Methods in Enzymology 579, (Elsevier Inc., 2016)). For some proteins, this is the most difficult obstacle to overcome, as a large proportion of protein particles tend to be absorbed to the air-water interface (AWI) in grids, which makes high-resolution structural determinations difficult.

The AWI is the main factor causing serious problems in sample preparation, because the process for particles migrating to the AWI is much faster than the vitrification process of specimen by plunge-freezing (Lyumkis, J. Biol. Chem. 294, 5181-5197 (2019)). As a result, the particles absorbed and trapped in the AWI may partially unfold and cause structural deformation or even denaturation (Glaeser, Curr. Opin. Colloid Interface Sci. 34, 1-8 (2018)). Another common situation is that the particles in the AWI exhibit strong orientation preference (Drulyte, Acta Crystallogr. Sect. D Struct. Biol. 74, 560-571 (2018)). Insufficient native conformations of protein particles in random orientations makes reconstructing a reliable three-dimensional structure at high-resolution difficult, if not impossible (Lyumkis, J. Biol. Chem. 294, 5181-5197 (2019)).

Several methods have been developed to improve particle behavior in vitreous ice. In some cases, adding detergent, such as 3-[(3-cholamidopropyl)dimethylammonio]-1-propanesulfonate (CHPASO), can eliminate particle adsorption to the AWI (Chen, et al., J. Struct. Biol. X 1, 100005 (2019)). In addition, coating of cryo-EM grids with a thin layer of graphene materials as supporting film also improves sample quality in vitreous ice (Han, et al., Proc. Natl. Acad. Sci. U.S.A 117, 1009-1014 (2020); Wang, et al., J. Struct. Biol. 209, 107437 (2020); Liu, et al., J. Am. Chem. Soc. 141, 4016-4025 (2019)). Furthermore, effect of the AWI can be reduced by using a new rapid plunge-freezing robots, Spotiton, by decreasing the plunge-freezing time compared to conventional vitrification devices (Jain, et al., J. Struct. Biol. 179, 68-75 (2012); Noble, et al., Nat. Methods 15, 793-795 (2018)). In addition, collecting tilted images can also address the insignificant preferred orientation problem (Zi Tan, et al., Nat. Methods 14, 793-796 (2017)). However, the requirement of special devices or complicated techniques limit the wide application of these methods. Accordingly, there remains a need for the development of improved imaging of samples.

Therefore, it is an object of the invention to provide methods and compositions for the improved and facile imaging of samples, such as biological samples.

It is another object of the invention to provide methods and compositions for the improved and facile imaging of samples, such as biological samples, via cryo-electron microscopy or cryo-electron tomography.

It is a further object of the invention to provide methods and compositions for the improved and facile imaging of samples, such as biological samples, via cryo-electron microscopy or cryo-electron tomography, by preparing the samples with metallo-supramolecular branched polymers.

### SUMMARY OF THE INVENTION

Disclosed are methods and compositions for use in preparing biological samples for high resolution structural determination via cryo-electron microscopy or cryo-electron tomography. Preferably, the biological samples are dynamic, i.e., possess more than one physical conformation, such as dynamic biological macromolecules. The methods involve preparing metallo-supramolecular branched polymers in situ in the presence of the biological sample(s) to be imaged. Following sample preparation, the methods involve plunge-freezing, in a cryogen, the composition containing the sample whose structure/structural features are to be determined, and the metallo-supramolecular branched polymer. Preferably, the metallo-supramolecular branched polymer contains a hydrophilic polymer segment, a chelating chemical group, and a metal ion, wherein the polymer is covalently bonded to the chelating chemical group that is in turn bonded to the metal ion via a dative bond. Preferably, the metallo-supramolecular branched polymer has an overall positive charge, as determined by its surface zeta potential.

The methods and compositions improve particle distribution in vitreous ice by protecting particles from the air-water interface. Further, the methods and compositions can change particle orientations in vitreous ice, and thus alleviate the preferred orientation problem observed in certain biological macromolecules. Accordingly, the methods and compositions can be utilized to improve particle distribution for high resolution structure determination using single-particle cryo-EM.

### BRIEF DESCRIPTION OF THE DRAWINGS

FIG. 1A is a workflow diagram showing a non-limiting example of cryo-EM data processing of a protein (such as apoferritin) with the number of particles and the reconstruction resolution indicated at every step. FIG. 1B is a line graph showing Fourier Shell Correlation (FSC) curves of the 3D reconstructions of the protein particles. The arrow indicates the resolution (tight crossover with the FSC=0.143). FIG. 1C is a schematic showing interactions between a protein and an MSBP.

FIG. 2A is a schematic showing the non-limiting formation of an MSBP, and its local structure in solution. Workflow for preparation of apoferritin cryo-specimen with MSBP. FIG. 2B is schematic showing the preparation of a protein sample for cryo-electron microscopy imaging. In the non-limiting example, protein (such as apoferritin) was mixed with polymer (such as 2 mg/mL PEG₅₀₀₀) and metal salt (such as 0.24 mg/mL Pd(NO₃)₂). The composition was loaded onto a grid (such as a holey carbon grid). FIG. 2C is a representative cryo-EM density of one α-helix of apoferritin. The density is shown as grey mesh/surface and the corresponding structural model (PDB: 7KOD), with side chains of residues depicted to demonstrate the quality of the map.

FIGS. 3A and 3B are scatter plots showing particle distributions of samples (such as protein) in vitreous ice layer analyzed by cryo-ET. FIG. 3A shows localization of apoferritin particles without MSBP grid shown most of particles were absorbed to the top air-water interface. Particle distribution of a protein (such as apoferritin) without MSBP in three layers along the Z axis of a tomogram showed non-uniform distribution. Particles were picked by template matching in Dynamo. FIG. 3B shows localization of apoferritin particles with MSBP grid, depicting more uniform distribution. Particles were picked by template matching in Dynamo. Particle distribution of apoferritin with MSBP in three layers along the Z axis of the tomogram showed uniform distribution. Regular arranged small particles are observed in two air-water interfaces.

FIG. 4 is a bar graph showing orientation statistics of cryo-EM analysis of a protein particles (such as hemagglutinin (HA) trimer) in three different views. As shown, the top views are the preferred orientation of HA trimer without MSBP. The proportions of the side views and tilted views of HA trimer with MSBP increased significantly.

FIGS. 5A and 5B are line graphs showing Fourier Shell Correlation (FSC) curves of 3D reconstructions of protein particles (such as catalase). Local resolution and FSC curve of catalase with MSBP (FIG. 5A) or without MSBP (FIG. 5B). FIGS. 5C and 5D are schematics showing particle distribution of protein particles (such as catalase).

FIGS. 6A and 6B are line graphs showing Fourier Shell Correlation (FSC) curves of 3D reconstructions of protein particles (such as β-galactosidase). Local resolution and FSC curve of catalase with MSBP (FIG. 6A) or without MSBP (FIG. 6B). FIGS. 6C and 6D are schematics showing particle distribution of protein particles (such as β-galactosidase).

### DETAILED DESCRIPTION OF THE INVENTION

### I. Definitions

“Branch point,” as relates to a metallo-supramolecular branched polymer (MSBP), refers to chemical moiety that connects three or more segments of the polymer. Examples include a group 2 metal, a group 13 metal, a group 14 metal, a group 15 metal, or a transition metal.

“Chelating chemical groups” or “chelators” are known in the art, and refer to groups that form a bond with a metal atom, by donating a pair of electrons to the metal atom. The bond is commonly referred to as a dative bond. Chelators generally contain heteroatoms such as oxygen, nitrogen, sulfur, phosphorus, etc; a carbon atom with a lone pair of electrons; or a combination thereof. Examples of chelating chemical groups include (3,5-di(pyridin-4-yl)phenyl)methanol, ethylenediamine, diethylenetriamine, ethylenediaminetetraacetate, bipyridyl, terpyridyl, 1,2-bis(dimethylphosphino)ethane, bis(diphenylphosphino)ethane, acetate, acetylacetonate, polycarboxylic acids (oxalate, malonate, succinate, glutarate, adipate, maleate, citraconate, citric acid, tartaric acid, mucic acid, gluconic acid, or 5-hydroxybenzene-1,2,3,-tricarboxylic acid, etc.), meso-2,3-dimercaptosuccinic acid, etc.

“Hydrophilic,” as used herein, refers to the property of having affinity for water. For example, hydrophilic polymers (or hydrophilic polymer segments) are polymers (or polymer segments) which are primarily soluble in aqueous solutions and/or have a tendency to absorb water. In general, the more hydrophilic a polymer is, the more that polymer tends to dissolve in, mix with, or be wetted by water.

“Metallo-supramolecular branched polymer” refers to a branched polymer that contains one or more branch points, containing at least one metal atom.

### II. Compositions

Recent technological breakthroughs in single-particle cryo-electron microscopy (cryo-EM) or cryo-electron tomography (cryo-ET) have enhanced the imaging and subsequent structural determination of samples, such as dynamic biological macromolecules, at atomic resolution. To successfully obtain high-resolution three-dimensional (3D) reconstructions of the samples, two-dimensional (2D) projections of homogenous targets from different directions are typically required. However, due to the limited knowledge of the AWI, preparation of cryogenic specimen is still a trial-and-error process and, in many cases, the bottleneck to get structural information. Among these, preferred orientation of specimen and attraction/accumulation of particles in the AWI are common problems in practice.

The disclosed methods and compositions involve the use of and contain metallo-supramolecular branched polymers, respectively, in the cryo-sample preparation process for high resolution structural determination using single-particle cryo-EM. Further, cryo-ET analysis demonstrated the feasibility of employing these methods and compositions to improve particle distribution in vitreous ice by protecting particles from the AWI. The disclosed methods and compositions can also change particles orientation in vitreous ice, and thus alleviate preferred orientation problem. Accordingly, the methods and compositions can be applied to improve particle distribution for high resolution structure determination using single-particle cryo-EM.

In some forms, the methods involve imaging a frozen composition containing a sample whose structure/structural features are to be determined, and a metallo-supramolecular branched polymer (MSBP). In some forms, the composition contains ice. The ice can be amorphous ice (i.e., vitreous ice), cubic ice, hexagonal ice, or a combination thereof. Generally, prior to collecting images of the sample, the composition is flash-frozen (such as via plunge-freezing) using a cryogenic fluid, such as liquid ethane or a mixture of liquid ethane and propane, cooled by appropriate fluids, such as liquid nitrogen.

### (i) Samples

The maximum size of a sample to be imaged is limited only by the penetration depth of the electron beam employed in the imaging process. On the other hand, the minimum size of a sample is limited by the image contrast generated by the electron intensity that can be tolerated by the sample. Preferably, the samples to be imaged are dynamic samples. Preferably, the samples to be imaged are biological samples, such as dynamic biological samples. Exemplary biological samples include biomacromolecules, helical fiber complexes, virus particles, bacteria, cells, tissues, organs, or a combination thereof. Depending on the sample, the imaging method can be cryo-EM or cryo-ET. For instance, with biomacromolecules, helical fiber complexes, virus particles, and virus-like particles, cryo-EM can be used, while for bacteria, cells, tissues, or organs cryo-ET can be use. For cryo-ET of the entire proteome of these samples, additional analytical methods can be used to further analyze the dense images.

In some forms, the biomacromolecules are proteins. In some forms, the proteins are single protein molecules, large protein complexes, membrane proteins, nucleoprotein complexes, thin-protein crystals, and combinations thereof.

### (ii) Metallo-Supramolecular Branched Polymers

The disclosed MSBPs contain a metal, a polymer segment, and or a chelating chemical group. In some forms, the MSBPs contain a metal and a polymer segment. In some forms, the MSBPs contain a metal, a polymer segment, and a chelating chemical group or chelator. In some forms, the MSBPs contain a metal, a hydrophilic polymer segment, and a chelating chemical group or chelator. Preferably, the polymer segment is bonded to a chelating chemical group or chelator that is bonded to the metal via one or more dative bonds. Preferably, the polymer segment is covalently bonded to a chelating chemical group or chelator that is bonded to the metal via one or more dative bonds.

In some forms, the MSBP is hydrophilic. In some forms, the MSBP (i) contains local regions having a positive electrostatic potential or positive charge, (ii) has an overall positive charge, or (iii) a combination thereof. Preferably the MSBP has an overall positive charge, as determined by its zeta potential. The zeta-potential can be between about +1 mV and about +60 mV, between about +1 mV and about +50 mV, between about +1 mV and about +40 mV, between about +5 mV and about +60 mV, between about +10 mV and about +60 mV, between about +5 mV and about +40 mV, between about +10 mV and about +50 mV, between about +15 mV and about +40 mV, between about +20 mV and about +40 mV, such as about +30 mV.

### (a) Metals

Metals capable of forming cross-links are preferred metals to be included in the MSBPs described herein. Generally, these metals are metals that have multiply charged oxidations states, that have empty high energy orbitals (p-, d-, f-orbitals, etc.) that can accept electrons from a donor atom, or a combination thereof. Examples of suitable metals include group 2 metals, group 13 metals, group 14 metals, group 15 metals, transition metals, and combinations thereof.

In some forms, the metal is a transition metal. In some forms, the metal is a group 10 transition metal.

In some forms, the metal has an oxidation state of 0, +1, +2, +3, +4, +4, +6, or +7. In some forms, the metal is positively charged, i.e., an oxidation state of +1, +2, +3, +4, +4, +6, or +7. In some forms, the metal has a +2 oxidation state, such as Pd²⁺.

### (b) Polymer Segment

Preferably, the MSBPs contain a polymer segment that contains a hydrophilic polymer segment.

In some forms, the MSBP contains a structure:

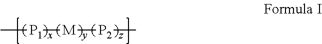

wherein:
x, y, and z are independently integers from 1 to 1,000, 1 to 500, 1 to 100, 1 to 50, or 1 to 10,
P₁, M, and P₂ are independently:

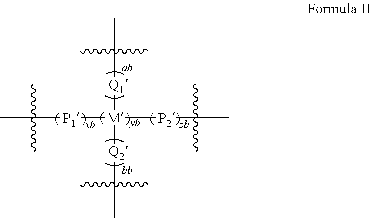

wherein:
xb and zb are independently integers from 0 to 1,000, with the proviso that xb+zb is at least 1,
yb is independently an integer from 1 to 1,000, ab and bb are independently integers from 0 to 1,000, with the proviso that ab+bb is at least 1, in at least one of P₁, M, and P₂,
P₁′, P₂′, Q₁′, and Q₂′ are independently a polymer segment, polymer segment-Lig, Lig-polymer segment-Lig′, a group 2 metal, a group 13 metal, a group 14 metal, a group 15 metal, a transition metal, wherein Lig and Lig′ are independently a monodentate ligand or multi-dentate ligand (such as bidentate, tridentate, tetradentate, pentadentate, or hexadentate),
each M′ is independently a metal with an oxidation state of 0, +1, +2, +3, +4, +4, +6, or +7, preferably a group 10 metal, preferably having an oxidation state of +2,
with the proviso that the BP contains a structure:

polymer segment [symbol] Lig [symbol] M″ [symbol] Lig′ [symbol] polymer segment

preferably, wherein at least one polymer segment contains a hydrophilic polymer segment.

Suitable hydrophilic polymers that can be included in the hydrophilic polymer segment include, but are not limited to, polyalkylene glycols and polyalkylene oxides such as polyethylene glycol (PEG); polysaccharides such as celluloses, alginates, glucosaminoglycans, and dextrans; hydrophilic polypeptides and poly(amino acids) such as poly-L-glutamic acid, gamma-polyglutamic acid, poly-L-aspartic acid, and poly-L-serine; poly(oxyethylated polyol); poly(olefinic alcohol) such as poly(vinyl alcohol) and aminoacetalized poly(vinyl alcohol); poly(N-vinylpyrrolidone); acrylic or acrylate, and alkacrylic or alkacrylate polymers such as poly(acrylic acid), poly(methacrylic acid), poly(hydroxyethyl acrylate); poly(N,N-dimethylaminoethyl methacrylate), poly(hydroxyalkyl methacrylate) e.g. poly(hydroxyethyl methacrylate); acrylamide polymers such as poly(acrylamide), poly(hydroxyalkyl methacrylamide), e.g., poly(hydroxyethyl methacrylamide; and poly(4-vinylpyridine); and copolymers thereof.

Preferably, the hydrophilic polymer segment contains a neutral hydrophilic polymer, such as a neutral uncharged hydrophilic polymer. Examples of neutral uncharged hydrophilic polymers include, but are not limited to, polyalkylene glycols and polyalkylene oxides such as polyethylene glycol (PEG); polysaccharides such as celluloses and dextrans; hydrophilic polypeptides and poly(amino acids) such as poly-L-serine; poly(oxyethylated polyol); poly(olefinic alcohol) such as poly(vinyl alcohol); poly(N-vinylpyrrolidone); poly(hydroxyethyl acrylate); poly(hydroxyalkyl methacrylate), e.g., poly(hydroxyethyl methacrylate).

Preferably, the hydrophilic polymer segment contains a neutral uncharged hydrophilic polymer, such as polyalkylene glycols and polyalkylene oxides such as polyethylene glycol.

### (c) Chelating Chemical Groups or Chelators

Preferably, the MSBPs contain chelating chemical groups, denoted in Formulae I and II above as Lig or Lig′. Preferably, the chelating chemical groups conjugate the other components of the MSBPs to one or more metal atoms therein, via one or more dative bonds. The chelating chemical groups are independently formed from (3,5-di(pyridin-4-yl)phenyl)methanol, ethylenediamine, diethylenetriamine, ethylenediaminetetraacetate, bipyridyl, terpyridyl, 1,2-bis(dimethylphosphino)ethane, bis(diphenylphosphino)ethane, acetate, acetylacetonate, polycarboxylic acids (oxalate, malonate, succinate, glutarate, adipate, maleate, citraconate, citric acid, tartaric acid, mucic acid, gluconic acid, or 5-hydroxybenzene-1,2,3,-tricarboxylic acid, etc.), meso-2,3-dimercaptosuccinic acid, or a combination thereof. In some forms, the chelating chemical groups are formed from (3,5-di(pyridin-4-yl)phenyl)methanol. Preferably, the chelating chemical groups contain (3,5-di(pyridin-4-yl)phenyl)methyl.

### III. Methods of Making and Reagents Therefor

The compounds in the methods and compositions described herein can be synthesized using methods known to those of skill in the art of organic chemistry synthesis. For instance, polymers, chelating chemical groups, and/or metal (such as elemental metals or metal salts) can be purchased from commercial chemical manufacturers or the MSBPs prepared. Exemplary and non-limiting syntheses of MSBPs are discussed in the Example below.

In some forms, the MSBP is formed by reacting:

Lig [symbol] PEG [symbol] Lig′

with a salt of a metal, such as a nitrate, where Lig and Lig′ contain one or more chelating chemical groups. In some forms, Lig-PEG-Lig′ has a structure:

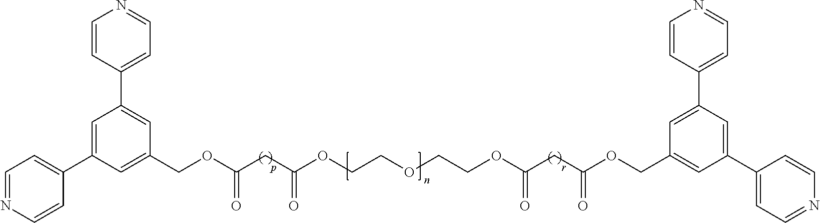

wherein:
p and r are independently integers from 1 to 10, such as 1, 2, 3, 4, 5, 6, 7, 8, 9, 10, preferably 2, and
n is an integer from 1 to 1,000, preferably such that the PEG has a molecular weight of between about 1 kDa and about 10 kDa, between about 2.5 kDa and about 7.5 kDa, such as about 5 kDa.

### IV. Methods of Using

The methods and compositions described herein, can be used in cryo-EM or cryo-ET of samples, preferably biological samples, for the elucidation of structural features of these samples, at atomic resolution. Preferably, the methods and compositions are utilized during the sample preparation stage of these analytical methods. The MSBPs can be formed prior to applying to the sample or is formed in situ in the presence of the sample to be imaged. Preferably, the MSBPs are formed in situ in the presence of the sample to be imaged. Subsequently, the composition containing the sample and MSBP is flash-frozen in a cryogen. A preferred method of flash-freezing is plunge-freezing, using a cryogenic fluid, such as liquid ethane or a mixture of liquid ethane and propane, cooled by appropriate fluids, such as liquid nitrogen.

Without wishing to be bound by theory, it is believed that the presence of the branched polymer in the solution changes the local viscosity of the solution (Yates and Hayes, Eur. Polym. J. 40, 1257-1281 (2004)) and impedes the absorption rate of the protein into the AWI. Alternatively, the MSBPs may be recruited to the AWI with a speed faster than protein particles and form a network that protects particles from absorption into AWI. Further, these MSBPs are preferably soluble (such as water-soluble) branched polymers containing hydrophilic polymer segments (such as neutral uncharged hydrophilic polymers, such as polyalkylene glycols and polyalkylene oxides such as polyethylene glycol) and metal-ligand coordination complex. Preferably, the MSBPs carry positive charges from the metal, and the charges are protected/wrapped inside small polymer clusters formed by the polymer segments. Meanwhile, proteins have surface charges that can interact with the MSBPs via electrostatic attractions (such as charge-charge interactions), which leads to binding between MSBPs and proteins. Importantly, the binding is very weak so that the MSBPs and proteins are only weakly associated. This is due to the unique structure of MSBPs, as the hydrophilic polymer segments can provide steric repulsion and/or charge shielding that prevent MSBPs getting permanently attached to protein. The weak association is important as the MSBPs, preferably being hydrophilic, prevent proteins from migrating to the AWI during sample preparation; at the same time, the MSPBs do not affect the structure of proteins for subsequent imaging with high resolution.

The disclosed methods and compositions be further understood through the following enumerated paragraphs or embodiments.
1. A method of imaging a sample, the method involving:
imaging a frozen composition containing (i) the sample and (ii) a metallo-supramolecular branched polymer (MSBP),
wherein the MSBP contains a metal with an oxidation state of 0, +1, +2, +3, +4, +4, +6, or +7, preferably wherein the metal is positively charged, such as +2 (such as Pd²⁺)
2. The method of paragraph 1, wherein the MSBP is hydrophilic.
3. The method of paragraph 1 or 2, wherein the MSBP (i) contains local regions having a positive electrostatic potential or positive charge, (ii) has an overall positive charge, or (iii) a combination thereof, preferably the MSBP has an overall positive charge.
4. The method of any one of paragraphs 1 to 3, wherein the composition contains ice, such as amorphous ice (i.e., vitreous ice), cubic ice, hexagonal ice, or a combination thereof.
5. The method of any one of paragraphs 1 to 4, involving flash-freezing (such as plunge-freezing) the composition in a cryogenic fluid prior to imaging.
6. The method of any one of paragraphs 1 to 5, involving processing the image to generate a structural model of the sample.
7. The method of any one of paragraphs 1 to 6, wherein imaging is performing using single-particle cryo-electron microscopy.
8. The method of any one of paragraphs 1 to 6, wherein imaging is performed using cryo-electron tomography.
9. The method of any one of paragraphs 1 to 8, wherein the sample contains biomacromolecules, helical fiber complexes, virus particles, virus-like particles, bacteria, cells, tissues, organs, or a combination thereof.
10. The method of any one of paragraphs 1 to 9, wherein the sample contains proteins, such as single protein molecules, large protein complexes, membrane proteins, nucleoprotein complexes, and thin-protein crystals.
11. The method of any one of paragraphs 1 to 10, wherein the metal is bonded to one or more other components of the MSBP via dative bonds.
12. The method of any one of paragraphs 1 to 11, wherein the MSBP contains a hydrophilic polymer segment.
13. The method of any one of claims 1 to 12, wherein the MSBP contains a structure:

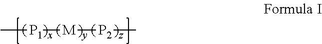

wherein:
x, y, and z are independently integers from 1 to 1,000, 1 to 500, 1 to 100, 1 to 50, or 1 to 10,
P₁, M, and P₂ are independently:

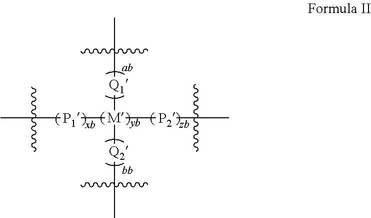

wherein:
xb and zb are independently integers from 0 to 1,000, with the proviso that xb+zb is at least 1,
yb is independently an integer from 1 to 1,000, ab and bb are independently integers from 0 to 1,000, with the proviso that ab+bb is at least 1, in at least one of P₁, M, and P₂,
P₁′, P₂′, Q₁′, and Q₂′ are independently a polymer segment, polymer segment-Lig, Lig-polymer segment-Lig′, a group 2 metal, a group 13 metal, a group 14 metal, a group 15 metal, a transition metal, wherein Lig and Lig′ are independently a monodentate ligand or multi-dentate ligand (such as bidentate, tridentate, tetradentate, pentadentate, or hexadentate),
each M′ is independently a metal with an oxidation state of 0, +1, +2, +3, +4, +4, +6, or +7, preferably a group 10 metal, preferably having an oxidation state of +2,
with the proviso that the MSBP contains a structure:

polymer segment [symbol] Lig [symbol] M′ [symbol] Lig′ [symbol] polymer segment
preferably, wherein at least one polymer segment contains a hydrophilic polymer segment.
14. The method of paragraph 13, wherein Lig and Lig′ independently contain one or more chelating chemical groups.
15. The method of paragraph 13 or 14, wherein Lig and Lig′ are independently formed from (3,5-di(pyridin-4-yl)phenyl)methanol, ethylenediamine, diethylenetriamine, ethylenediaminetetraacetate, bipyridyl, terpyridyl, 1,2-bis(dimethylphosphino)ethane, bis(diphenylphosphino)ethane, acetate, acetylacetonate, polycarboxylic acids (oxalate, malonate, succinate, glutarate, adipate, maleate, citraconate, citric acid, tartaric acid, mucic acid, gluconic acid, or 5-hydroxybenzene-1,2,3,-tricarboxylic acid, etc.), meso-2,3-dimercaptosuccinic acid, or a combination thereof.
16. The method of any one of paragraphs 13 to 15, wherein Lig and Lig′ are formed from (3,5-di(pyridin-4-yl)phenyl)methanol.
17. The method of any one of paragraphs 13 to 16, wherein Lig and Lig′ independently contain (3,5-di(pyridin-4-yl)phenyl)methyl.
18. The method of any one of paragraphs 1 to 17, wherein one or more polymer segments of the MSBP contain polyalkylene glycols and polyalkylene oxides such as polyethylene glycol (PEG); polysaccharides such as celluloses, alginates, glucosaminoglycans, and dextrans; hydrophilic polypeptides and poly(amino acids) such as poly-L-glutamic acid, gamma-polyglutamic acid, poly-L-aspartic acid, and poly-L-serine; poly(oxyethylated polyol); poly(olefinic alcohol) such as poly(vinyl alcohol) and aminoacetalized poly(vinyl alcohol); poly(N-vinylpyrrolidone); acrylic or acrylate, and alkacrylic or alkacrylate polymers such as poly(acrylic acid), poly(methacrylic acid), poly(hydroxyethyl acrylate); poly(N,N-dimethylaminoethyl methacrylate), poly(hydroxyalkyl methacrylate) such as poly(hydroxyethyl methacrylate); acrylamide polymers such as poly(acrylamide), poly(hydroxyalkyl methacrylamide) such as poly(hydroxyethyl methacrylamide; and poly(4-vinylpyridine); and copolymers thereof.
19. The method of any one of paragraphs 1 to 18, wherein one or more polymer segments of the MSBP contain a neutral hydrophilic polymer, preferably a neutral hydrophilic polymer, such as a neutral uncharged hydrophilic polymer.
20. The method of any one of paragraphs 1 to 19, wherein one or more polymer segments of the MSBP contain polyalkylene glycols and polyalkylene oxides such as PEG.
21. The method of any one of paragraphs 1 to 20, wherein the MSBP is formed by reacting:

Lig [symbol] PEG [symbol] Lig′

with a salt of the metal, such as a nitrate.
22. The method of 21, wherein Lig-PEG-Lig′ has a structure:

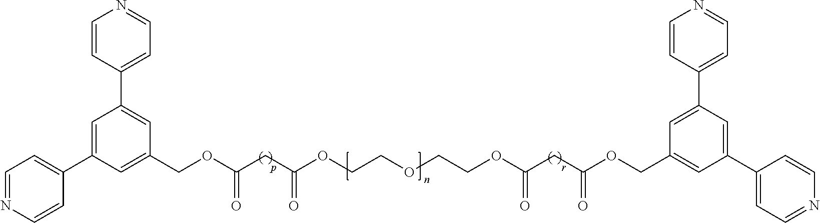

wherein:
p and r are independently integers from 1 to 10, such as 1, 2, 3, 4, 5, 6, 7, 8, 9, 10, preferably 2, and
n is an integer from 1 to 1,000, preferably such that the PEG has a molecular weight of between about 1 kDa and about 10 kDa, between about 2.5 kDa and about 7.5 kDa, such as about 5 kDa.
23. A composition containing a sample, preferably a biological sample, and an MSBP,
wherein the MSBP contains a structure:

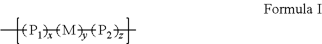

wherein:
x, y, and z are independently integers from 1 to 1,000, 1 to 500, 1 to 100, 1 to 50, or 1 to 10, P₁, M, and P₂ are independently:

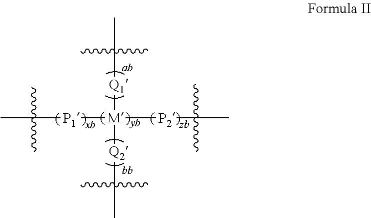

wherein:
xb and zb are independently integers from 0 to 1,000, with the proviso that xb+zb is at least 1,
yb is independently an integer from 1 to 1,000, ab and bb are independently integers from 0 to 1,000, with the proviso that ab+bb is at least 1, in at least one of P₁, M, and P₂,
P₁′, P₂′, Q₁′, and Q₂′ are independently a polymer segment, polymer segment-Lig, Lig-polymer segment-Lig′, a group 2 metal, a group 13 metal, a group 14 metal, a group 15 metal, a transition metal, wherein Lig and Lig′ are independently a monodentate ligand or multi-dentate ligand (such as bidentate, tridentate, tetradentate, pentadentate, or hexadentate),
each M′ is independently a metal with an oxidation state of 0, +1, +2, +3, +4, +4, +6, or +7, preferably a group 10 metal, preferably having an oxidation state of +2,
with the proviso that the MSBP contains a structure:

polymer segment [symbol] Lig [symbol] M′ [symbol] Lig′ [symbol] polymer segment

preferably, wherein at least one polymer segment contains a neutral hydrophilic polymer segment, such as a neutral uncharged hydrophilic polymer.
24. The composition of paragraph 23, wherein Lig and Lig′ independently contain one or more chelating chemical groups.
25. The composition of paragraph 23 or 24, wherein one or more polymer segments of the MSBP contain polyalkylene glycols and polyalkylene oxides such as PEG.
26. The composition of any one of paragraphs 23 to 25, wherein the MSBP is formed by reacting:

Lig [symbol] PEG [symbol] Lig′

with a salt of the metal, such as a nitrate. [symbol]
27. The composition of paragraph 26, wherein Lig-PEG-Lig′ has a structure:

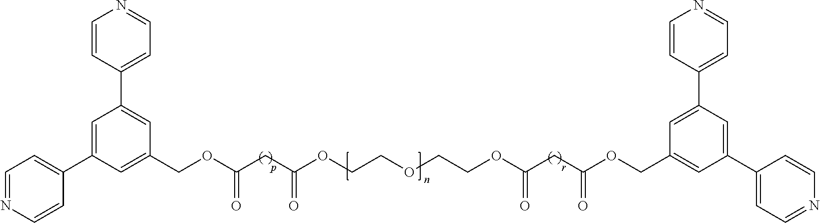

wherein:
p and r are independently integers from 1 to 10, such as 1, 2, 3, 4, 5, 6, 7, 8, 9, 10, preferably 2, and
n is an integer from 1 to 1,000, preferably such that the PEG has a molecular weight of between about 1 kDa and about 10 kDa, between about 2.5 kDa and about 7.5 kDa, such as about 5 kDa.
28. The composition of any one of paragraphs 23 to 27, wherein Lig and Lig′ are independently formed from (3,5-di(pyridin-4-yl)phenyl)methanol, ethylenediamine, diethylenetriamine, ethylenediaminetetraacetate, bipyridyl, terpyridyl, 1,2-bis(dimethylphosphino)ethane, bis(diphenylphosphino)ethane, acetate, acetylacetonate, polycarboxylic acids (oxalate, malonate, succinate, glutarate, adipate, maleate, citraconate, citric acid, tartaric acid, mucic acid, gluconic acid, or 5-hydroxybenzene-1,2,3,-tricarboxylic acid, etc.), meso-2,3-dimercaptosuccinic acid, or a combination thereof.
29. The composition of any one of paragraphs 23 to 28, wherein Lig and Lig′ are formed from (3,5-di(pyridin-4-yl)phenyl)methanol.
30. The composition of any one of paragraphs 23 to 29, wherein Lig and Lig′ independently contain (3,5-di(pyridin-4-yl)phenyl)methyl.
31. The composition of any one of paragraphs 23 to 30, wherein the MSBP (i) contains local regions having a positive electrostatic potential or positive charge, (ii) has an overall positive charge, or (iii) a combination thereof, preferably the MSBP has an overall positive charge.
32. The composition of any one of paragraphs 23 to 31, wherein the composition contains ice, such as amorphous ice (i.e., vitreous ice), cubic ice, hexagonal ice, or a combination thereof.
33. The composition of any one of paragraphs 23 to 32, wherein the sample contains biomacromolecules, helical fiber complexes, virus particles, virus-like particles, bacteria, cells, tissues, organs, or a combination thereof.
34. The composition of any one of paragraphs 23 to 33, wherein the sample contains proteins, such as single protein molecules, large protein complexes, membrane proteins, nucleoprotein complexes, and thin-protein crystals.
35. The composition of any one of paragraphs 23 to 34, wherein the metal is bonded to Lig and/or Lig′ via dative bonds.

### EXAMPLES

### Example 1: Metallo-Supramolecular Branched Polymer Improves Particle Distribution and Orientation in Single-Particle Cryo-Electron Microscopy

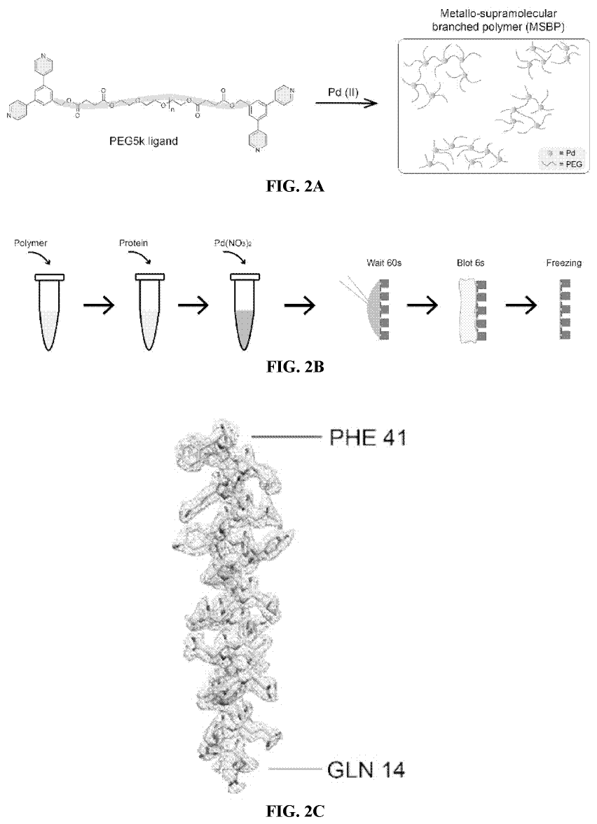

Metallo-supramolecular polymers are an emerging type of material that combines the advantages of traditional polymers with coordination chemistry. They can be synthesized by simply mixing polymeric ligands with metal ions to generate tailored structures and properties (charges, magnetic and mechanical properties, etc.) (Beck, et al., Macromolecules 38, 5060-5068 (2005); Winter and Schubert, Chemical Society Reviews 45, 5311-5357 (2016); Whittell, et al., Nature Materials 10, 176-188 (2011)). In this work, metallo-supramolecular branched polymers were developed as additives to assist in the single-particle cryo-EM. Polyethylene glycol (PEG) was employed, which has been extensively used in a variety of fields, including nanotechnology, nanomedicine and electron microscopy due to their biocompatibility and chemical stability at the relevant milieu (Zalipsky and Harris, ACS Symp. Ser. 680, 1-13 (1997); Wolosewick, J. Cell Biol. 86, 675-681 (1980)). The MSBP was formed by functionalizing the chain ends of the PEG with bispyridyl ligands and introducing palladium ions (Pd²⁺) at room temperature (FIG. 2A). This and related systems were previously shown to form hyper-branched polymer architectures (Zhukhovitskiy, Nat. Chem. 8, 33-41 (2016); Zhukhovitskiy, Macromolecules 49, 6896-6902 (2016); Wang, et al., Angew. Chemie—Int. Ed. 56, 188-192 (2017); Gu, et al., Nature 560, 65-69 (2018); Oldenhuis, et al., Angew. Chemie 132, 2806-2814 (2020)), which may potentially surround and trap the proteins in the center of the solution, thus protecting the proteins from migrating to the AWI.

Here, studies are disclosed involving the introduction of MSBP in the sample preparation process, which significantly reduces the AWI effect. First, it was shown that apoferritin prepared using MSBP achieved a 2.16 Å high resolution by single-particle cryo-EM method. Second, it was shown using the cryo-ET technique that apoferritin particles with MSBP are uniformly distributed in the central layer of vitreous ice in the composition, avoiding assembling at the AWI observed for apoferritin without MSBP. In addition, using hemagglutinin (HA) trimer as an example, it was shown that the previously reported preferred orientation problem of HA trimer (Noble, et al., Nat. Methods 15, 793-795 (2018)) was minimized in cryo-grids prepared with MSBP. The MSBP was also used in sample preparations of catalase and β-galactosidase. The results demonstrate that applying MSBPs improves particle distribution and orientation of cryo-specimen in vitreous ice for single-particle cryo-EM study, and/or reduces diffusion of samples to the AWI interface.

### Materials and Methods

(i) Synthesis of bispyridyl polyethylene glycol (bispyridyl PEG)

Synthesis of succinylated bispyridyl ligand L-COOH. 4-((3,5-di(pyridin-4-yl)benzyl)oxy)-4-oxobutanoic acid. [3,5-di(pyridine-4-yl)phenyl]methanol (2.5 g, 9.54 mmol), succinic anhydride (1.15 g, 11.5 mmol), and 4-dimethylaminopyridine (1.4 g, 11.5 mmol) were added to a 50-mL Schlenk flask equipped with a magnetic stirring bar. The flask was capped with a septum and evacuated and refilled with nitrogen three times. To the flask via syringe were added 30 mL of anhydrous dichloromethane (DCM) under nitrogen. The flask was placed at room temperature overnight. The contents of the flask were concentrated via rotary evaporation to give crude product that was subjected to chromatography on silica gel (CH₂CL₂/MeOH/CH₃COOH step gradient, 10:0:0→97:1.5:1.5→94:3:3); the fractions containing desired product were combined, concentrated to yield a light yellow solid. The product was further purified by washing with de-ionized water 8-10 times to remove excess succinic acid and acetic acid, and dried by lyophilization to give off-white powdery solid. High-resolution mass spectrometry (EI): calcd. for C₂₁H₁₈O₄N₂, most abundant m/z=362.1261; found, 362.1270.

Polyethylene glycol was then coupled with the succinylated ligand via a DIC (N,N′-diisopropylcarbodiimide) mediating coupling protocol. Typically, OH-PEG₅ₖ-OH (300 mg, 0.06 mmol), the succinylated bispyridyl ligand (87 mg, 0.24 mmol), and 4-dimethylaminopyridine (8.0 mg, 0.065 mmol) were added to a 25-mL Schlenk flask equipped with a magnetic stirring bar. The flask was capped with a septum and evacuated and refilled with nitrogen three times. To the flask via syringe were added 10 mL anhydrous dichloromethane (DCM) and 2 mL anhydrous N,N-dimethylformamide (DMF) under nitrogen. DIC (80 μL, 0.52 mmol) was then added under nitrogen. The flask was placed at room temperature for 48 h. The crude product was purified by prep-HPLC, eluent flow rate was 10 mL/min, and the eluent composition consisted of mixtures of ultrapure water and HPLC grade acetonitrile. The eluent gradient had a linear ramp from 35% to 80% acetonitrile during 0-30 min, followed by a ramp to 95% acetonitrile during 30-45 min. Fractions containing the product were combined, frozen and lyophilized. The MSBPs displayed well-defined structures, and a positive surface charge, indicated by a zeta potential of +30 mV.

### (ii) Sample Preparation

### (a) Cryo-Grids Preparation of Apoferritin

The mouse heavy chain apoferritin sample was expressed and purified following standard protocols (Wu, et al., J. Struct. Biol. X 4, 100020 (2020)). Bispyridyl PEG-5k was dissolved to 50 mg/ml in H₂O, and Pd(NO₃)₂ was dissolved to 5 mg/ml in DMSO as stock solution. The stock solution was further diluted to the indicated concentrations using buffer the same as proteins before mixing with protein sample. The holey carbon grids (Quantifoil 300 mesh Cu R1.2/1.3) were glow-discharged for 30 s before application of all cryo-specimens used in this study.

For single-particle cryo-EM grid, 1 μL apoferritin (2 mg/ml), 1 μL Lig-PEG-Lig′ (such as bispyridyl-PEG-bispyridyl) (6 mg/ml) and 1 μL Pd(NO₃)₂ (0.72 mg/ml) were well mixed and applied to holey carbon grids. After 60 s incubation on the grids at 22° C. under 100% humidity, the grids were blotted with filter paper (TED PELLA 595) for 6 s and plunge-frozen into liquid ethane cooled by liquid nitrogen using a FEI MarkIV Vitrobot. To prepare cryo-grids for cryo-ET studies, a similar protocol was used except gold tracers (BSA tracer Conventional, 10 nm, AURION) were mixed with sample before loading to the grids. The MSBP grids were prepared by replacing apoferritin by buffer.

### (b) Cryo-Grids Preparation of Hemagglutinin

The HA trimer recombinant protein purchased from MyBioSource (Catalog number MBS434205) was dissolved in PBS buffer to indicated concentration. To prepare HA trimer only grid, 3 μL 0.75 mg/ml HA trimer was applied to holey carbon grid (Quantifoil 400 mesh Au R1.2/1.3) which was glow discharged 30 s at 15 mA. After 30 s incubation at 22° C. under 100% humidity, the grid was blotted with filter paper (TED PELLA 595) for 4 s and plunge-frozen into liquid ethane cooled by liquid nitrogen. The HA trimer with MSBP grids were prepared using a similar protocol except 3 μL 1 mg/ml HA trimer, 0.5 μL 16 mg/ml PEG5000 and 0.5 μL 1.92 mg/ml Pd(NO₃)₂ were mixed before loading to the grids.

### (iii) Data Collection and Processing

All cryo-EM data collection was done with a FEI Titan Krios G3i electron microscope (Thermo Fisher Scientific) equipped with a high-brightness field emission gun operated at 300 kV.

For single-particle cryo-EM, images were recorded with a K3 Summit direct electron detector (Gatan) using EPU (Hillsboro, T. P. EPU Software User's Guide) in counting mode at a calibrated magnification of 81,000×(1.06 Å physical pixel size). The slit width of the Gatan Imaging Filter (GIF) Bio Quantum was set to 20 eV. 1587 micrographs were collected over 8 s with 7.13 e⁻/Å²/s dose rate for the dataset of apoferritin with MSBP. 576 micrographs were collected over 5 s with 10.35 e⁻/Å²/s dose rate for the dataset of HA trimer. 965 micrographs were collected over 5 s with 10.45 e⁻/Å²/s dose rate for the dataset of HA trimer with MSBP. All micrographs with 40 frames were collected with defocus values from −2.5 μm to −1.3 μm.

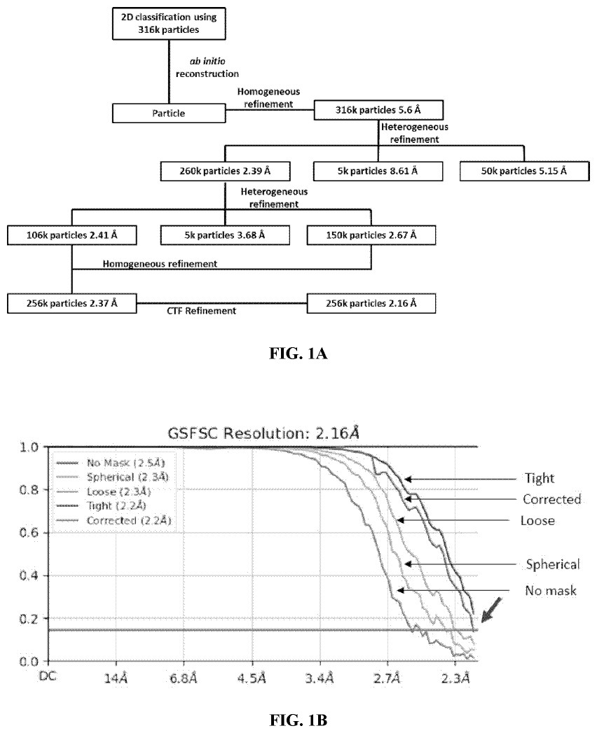

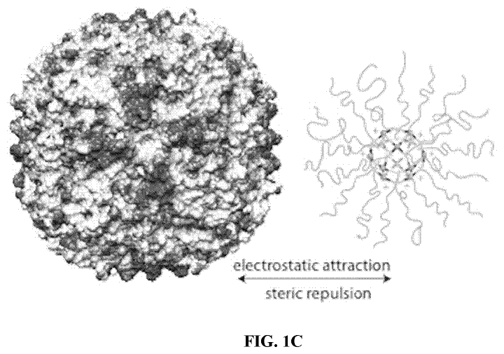

Drift correction of the micrographs was performed using MotionCor2 (Zheng, et al., Nat. Methods 14, 331-332 (2017)). Motion-corrected sums without does-weighting were used for contrast transfer function (CTF) estimation with GCTF (Zhang, J. Struct. Biol. 193, 1-12 (2016)). Motion-corrected sums with dose-weighting were used for all other image processing. Particles picked by Gautomatch (https://www.mrclmb.cam.ac.uk/kzhang/Gautomatch/) were extracted by RELION (Zivanov, et al., IUCrJ 7, 253-267 (2020)) and then imported into CryoSPARC (Punjani, et al., Nat. Methods 14, 290-296 (2017)) for further processing. The initial model was generated using ab initio reconstruction. Well-sorted particles by iterative 2D classification and heterogeneous refinement were finally subjected to homogenous and non-uniform refinement to generate the final maps. CTF refinement was performed to further improve the final resolution. Detailed information of data processing can be found in FIGS. 1A and 1B.

Similar approaches were used to process the HA trimer dataset. In this case, 2D averages were used to evaluate the angular distribution of the particles. The final 2D classification results for HA trimer with or without MSBP show that the preferred orientation problem of HA has been alleviated by introducing more side and tilted views when applying MSBP in cryo-sample preparation.

For Cryo-ET data, tilt series from −60° to 60° with 3° increments, were collected with a K3 Summit direct electron detector (Gatan) using Tomography (Thermo Fisher Scientific) (Benefits, K. Tomography 5 Software. 3-6) in counting mode at a calibrated magnification of 42,000×(2.09 Å physical pixel size). A total dose of 2.16 e⁻/Å² (for apoferritin only and MSBP only), 2.92 e⁻/Å² (for apoferritin with MSBP) and 2.72 e⁻/Å² (for apoferritin with PEG and apoferritin with Pd(NO₃)₂) was used to expose every micrograph for around is (4 frames per image) with a defocus near −4 μm.

The micrographs were aligned by MotionCor2 without CTF correction. The tilt series were aligned based on gold fiducials by making seed model manually in Etomo (Kremer, et al., J. Struct. Biol. 116, 71-76 (1996)). After the generation of tomograms, the particles were picked by template matching in Dynamo (Castaño-Diez, et al., J. Struct. Biol. 178, 139-151 (2012)).

### Results

(i) MSBP does not Affect the Final Resolution of Apoferritin

To demonstrate and/or ensure the practicality and biocompatibility of the disclosed approach for high resolution structural determination using single-particle cryo-EM, a cryo-specimen of apoferritin was prepared following the standard protocol except adding MSBP for the data collection and 3D reconstruction. Briefly, apoferritin was mixed with bispyridyl PEG (MW: 5,000 Da) and palladium nitrate; the mixture was then immediately applied to cryo-grids and incubated for several minutes to allow formation of metallo-supramolecular structure before blotting and plunge-freezing (FIG. 2B). The concentration of MSBP has been optimized to ensure proper ice thickness and reduced background noise caused by the metallo-supramolecular structure. A very low concentration (2 mg/ml) of the polymer was used to form a branched architecture, well below the gel point (about 30 mg/ml). Although the concentration of the polymer (2 mg/ml) used to form a branched architecture is well below the gel point (about 30 mg/ml), changes of the solution physical properties, especially the viscosity, were observed. The raw image of apoferritin prepared with MSBP showed homogenous and monodisperse apoferritin particles without background noise that may be contributed by the polymer. In addition, the overall ice quality in grids prepared using MSBP was even better than that in grids without application of MSBP (data not shown), indicating that the metallo-supramolecular structures may influence the AWI to improve reproducibility of cryo-grids by generating better vitreous ice. The good particles of apoferritin, sorted out by 2D and 3D classification, were used to generate 3D reconstructions. The final resolution, calculated using gold-standard Fourier shell correlation (FSC), was 2.16 Å, very close to Nyquist limit of acquired micrographs FIGS. 1A and 1B. Local resolutions showed high qualities that facilitated the fitting of individual residues from the published structure (PDB:7KOD) to the density map unambiguously (FIG. 2C). This result showed that application of MSBP in sample preparation of single-particle cryo-EM can achieve near-atomic resolution of proteins without introducing background noise.

### (ii) MSBP Improves Particle Distribution of Apoferritin

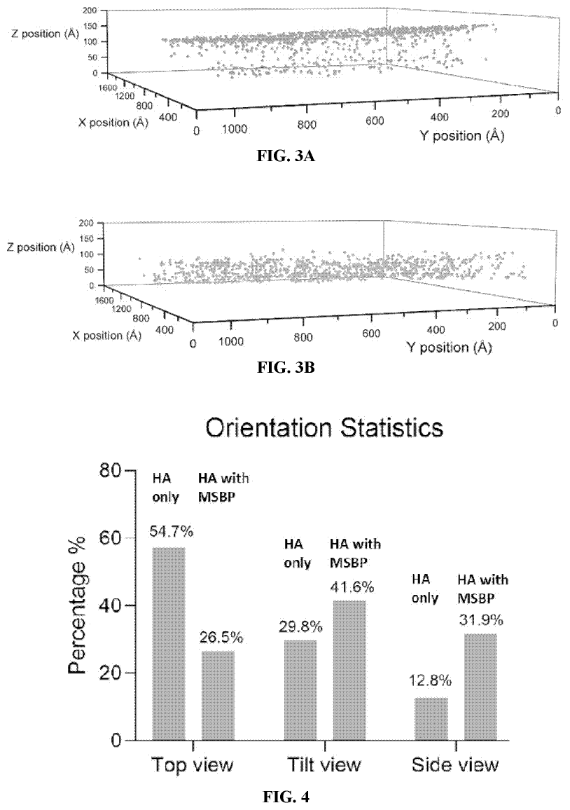

To further investigate whether MSBP can improve particle distribution in vitreous ice by preventing attraction of particles into the AWI during plunge freezing, the cryo-ET approach was utilized to locate individual particles in vitreous ice (Noble, et al., Nat. Methods 15, 793-795 (2018)). Cryo-ET dataset for apoferritin was collected with or without MSBP for comparison and picked individual particles automatically by template-matching from reconstructed tomograms. For apoferritin without MSBP, an abundance of apoferritin particles were trapped in the AWI, and only a small number of particles were found in the middle section of the tomogram (FIG. 3A). In contrast, for apoferritin treated with MSBP, particles were distributed uniformly throughout the vitreous ice layer with few particles appearing at the AWI (FIG. 3B). These distinct particle distributions are more apparent when compared in the side (Y-Z) views of the tomograms. Also, the apparent air-water interfaces, indicated by the big ice contaminations, showed a thinner ice layer for sample treated with MSBP. Cryo-ET datasets of apoferritin treated with PEG or palladium nitrate only were also collected and analyzed, both showing similar particle distribution as the dataset of apoferritin only. All these results showed that application of MSBP improves particle distribution in an even thinner vitreous ice by keeping particles away from AWI.

(iii) MSBP Alleviates Preferential Orientations

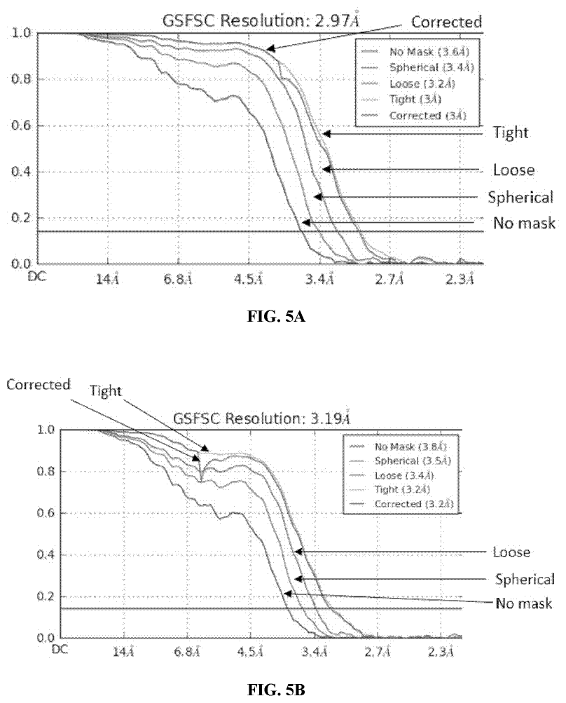

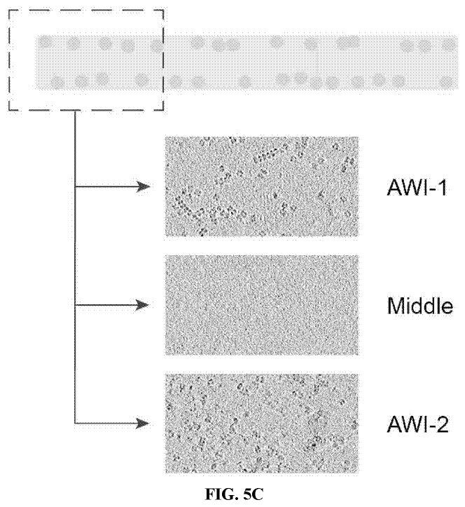

These studies also investigated whether particle orientations in vitreous ice were also changed by keeping away from the AWI. To test this hypothesis, single-particle cryo-EM datasets for hemagglutinin (HA) trimer treated with or without MSBP were collected and analyzed. After 2D classifications, HA trimer particles showed three distinct orientations: top view, side view, and tilted view. The number of particles grouped into each of these three categories were then calculated for the two respective datasets (FIG. 4).

The dataset of HA trimer without MSBP exhibited an apparent preferred orientation problem, with more than 50% of particles oriented in top views, while only about 10% particles showed typical side views, consistent with previous studies (Noble, et al., Nat. Methods 15, 793-795 (2018); Tan and Rubinstein, Acta Crystallogr. Sect. D Struct. Biol. 76, 1092-1103 (2020)). For HA trimer treated with MSBP, the proportion of particles representing top views decreased dramatically (from 54.7% to 26.5%), while particles from both side and tilted views increased correspondingly. It is also worth noting that particles were almost proportionately distributed into three different views in dataset of HA trimer treated with MSBP. 2D averages of top or side views both contained about 30% of total particles, while more than 40% particles were presented as tilted views, the largest category in this dataset. Comparing the statistics of the two HA datasets under different conditions clearly showed that the application of MSBP alleviated the preferred orientation problem of HA trimmer by protecting particles from AWI such that particles can rotate and distribute more freely in vitreous ice.

### (iv) Application of MSBPs in Cryo-EM Sample Preparation of Catalase

The protocols described above for apoferritin and HA were also employed to image the structures of catalase with or without MSBPs. The results further demonstrate that MSBPs improve the quality of cryo-specimen for single-particle cryo-EM studies.

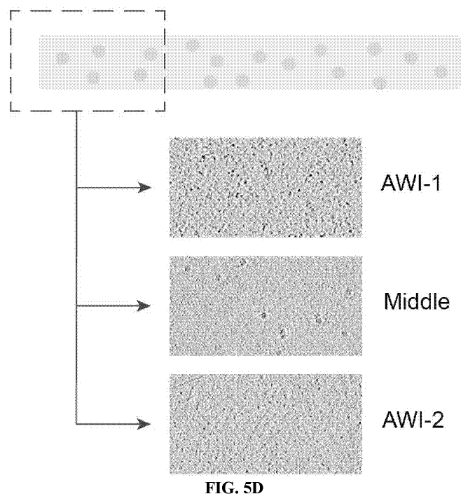

Single-particle cryo-EM results show that application of MSBP further improved the resolution of catalase from 3.19 Å to 2.97 Å reconstructed by using the same number of particles (FIGS. 5A and 5B). 2D class averages showed more evenly distributed particles for catalase with MSBP compared to catalase without MSBP. Further, angular distribution of particles used for final reconstruction indicated that the application of MSBP induced more views of catalase. Cryo-ET analysis revealed that MSPB shields particles away from the AWI, thus providing more random views for successful 3D reconstruction. FIGS. 5C (without MSPB) and 5D (with MSPB) are schematics showing particle distribution of catalase.

Lastly, catalase is a homotetramer, with four identical 50-kDa subunits. To further study the potential influence of background noise introduced by adding MSBP to cryo-EM samples, a systematic single-particle cryo-EM analysis was performed by using subtracted particles. For trimer (150 kDa) and dimer (100 kDa) of subtracted catalase, the 3D reconstruction was not affected too much, although the resolution dropped slightly due to limited particle numbers. In addition, symmetry expansion was applied before subtraction to generate monomer particles for reconstruction. The resolution and map quality were improved by using a larger number of particles, further demonstrating that increasing particle number can compensate resolution decrease of small proteins that might be caused by MSBPs.

### (v) Application of MSBPs in Cryo-EM Sample Preparation of β-Galactosidase

The protocols described above for apoferritin, HA, and catalase were also employed to image the structures of β-galactosidase with or without MSBPs. The results further demonstrate that MSBPs improve the quality of cryo-specimen for single-particle cryo-EM studies.

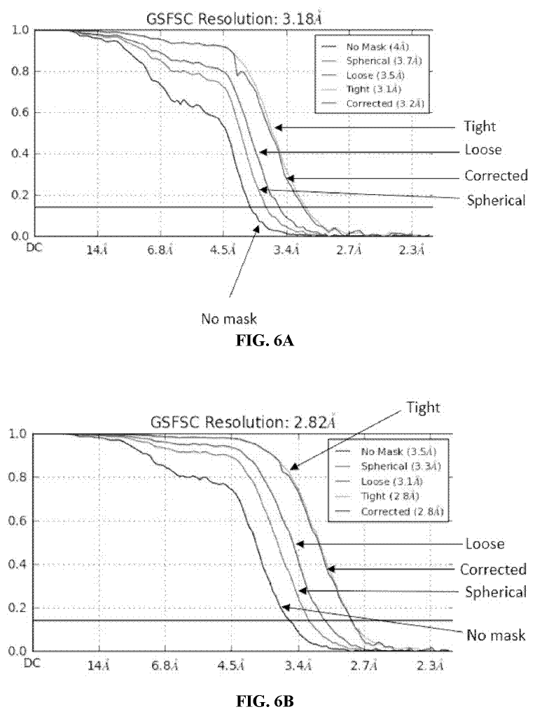

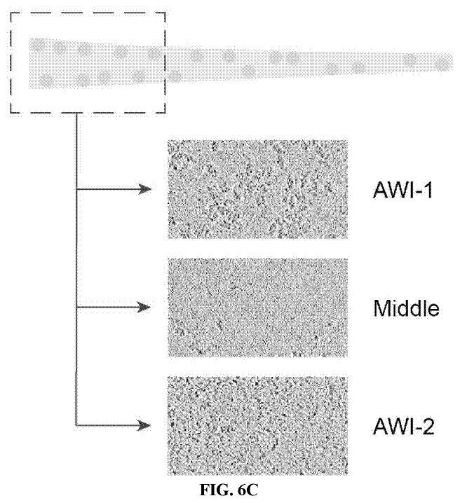

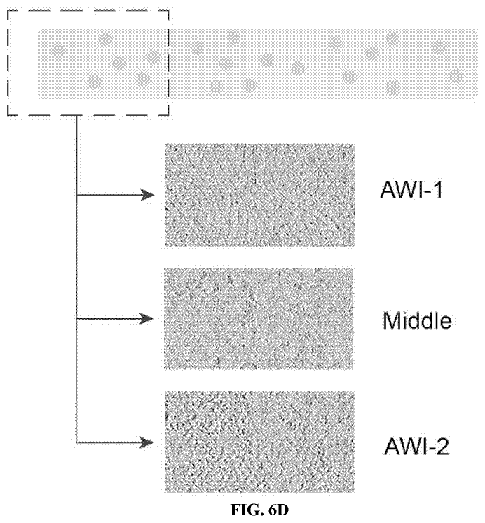

Single-particle cryo-EM results show that application of MSBP leads to the successful reconstruction of the structure of β-galactosidase at atomic resolution (3.18 Å), although the resolution dropped a little compared with the one without MSBP (FIGS. 6A and 6B). 2D class averages showed comparable particle distribution for β-galactosidase with MSBP. Nonetheless, the angular distribution of particles used for final reconstruction indicated that the application of MSBP induced more views of β-galactosidase. Further, cryo-ET analysis revealed that MSPB shields particles away from the AWI, thus providing more random views for successful 3D reconstruction. The reason for the lower resolution for β-galactosidase with MSBP could be due to a number of factors. A plausible one is the thicker ice for β-galactosidase with MSBP, which will lower the signal-to-noise ratio and influence the final resolution. The same number of particles was used to do reconstruction for β-galactosidase with or without MSBP for systematic comparison. In practice, the resolution of β-galactosidase with MSBP can be readily improved by collecting a larger dataset. Although the resolution is dropped slightly for β-galactosidase, the quality of the map is good for model building and further analysis. Further, a 3.2-Å resolution map is a relatively good map compared to maps deposited in the electron microscopy data bank. FIGS. 6C (without MSPB) and 6D (with MSPB) are schematics showing particle distribution of β-galactosidase.

It should be noted that a key benefit, observed in these studies, is that the MSBPs shielded particles from AWIs, thus providing more random views for successful reconstruction. For proteins, like HA trimer, that adopt preferred orientation in vitreous ice, the 3D reconstruction will be severely hindered in the absence of random views. Accordingly, the MSBPs are widely applicable to many samples (such as proteins in a wide molecular weight range range), and resolution improvement serves an additional benefit in some cases.

In summary, a method to improve particle behavior in vitreous ice by applying the MSBP for high-resolution single-particle cryo-EM structure determination has been developed and tested. The involvement of MSBP in cryo-specimen preparation not only reduces particles trapped at the AWI, but also alleviates the preferred orientation problem by producing more randomly distributed particles in vitreous ice. In addition to other reported methods such as modification of cryo-grids with graphene oxide, the disclosed approach provides a strategy to improve cryo-sample preparation conditions for challenging protein complexes that do not behave optimally on holey carbon grids.

The PEG-based polymers have many applications in the biology field, such as facilitating cytoskeletal organization of osteoblasts in bone tissue engineering (Burdick and Anseth, Biomaterials 23, 4315-4323 (2002)) and inhibition of cell migration (Raeber, et al., Biophys. J. 89, 1374-1388 (2005)). To the best of Applicant's knowledge, this is the first report of applying MSBP for sample preparations in cryo-EM study. Interestingly, in the air-water interfaces of cryo-grid prepared using MSBP, plenty of uniformly arranged small polymeric particles formed a network, which seemed to shield protein particles away from the AWI. Similar networks were not observed in cryo-grids prepared without the addition of MSBP, indicating that the network was formed by the MSBP.

Without wishing to be bound by theory, it is believed that the presence of the branched polymer in the solution changes the local viscosity of the solution (Yates and Hayes, Eur. Polym. J. 40, 1257-1281 (2004)) and impedes the absorption rate of the protein into the AWI. Alternatively, the MSBP may be recruited to the AWI with a speed faster than protein particles and form a network that protects particles from absorption into AWI. Further, these MSBPs are soluble (such as water-soluble) branched polymers based on PEG and metal-ligand coordination complex. The MSBPs carry positive charges from the metal—in this case palladium ions, and the charges are protected/wrapped inside small polymer clusters. On the other hand, proteins have surface charges that can interact with MSBP via electrostatic attractions, which leads to binding between MSBPs and proteins. Importantly, the binding is very weak so that the MSBPs and proteins are only weakly associated. This is due to the unique structure of MSBPs, as the PEG can provide steric repulsion that prevent MSBPs getting permanently attached to protein. The weak association is important as the MSBPs, being hydrophilic, will prevent protein from migrating to the air-water interface during sample preparation; at the same time, the MSPBs will not affect the structure of proteins for subsequent imaging with high resolution.

An important characteristic of MSBPs is that they can withstand extreme conditions (such as solution in quite high or quite low pH). The approach described here is applicable in cryo-sample preparation by diminishing AWI effects and eventually contribute to resolution improvement with a wide applicable potential, eventually benefitting the whole cryo-EM community.

Those skilled in the art will recognize, or be able to ascertain using no more than routine experimentation, many equivalents to the specific embodiments of the invention described herein. Such equivalents are intended to be encompassed by the following claims.

1. A method of imaging a sample, the method comprising:
imaging a frozen composition comprising (i) the sample and (ii) a metallo-supramolecular branched polymer (MSBP),
wherein the MSBP comprises a metal with an oxidation state of 0, +1, +2, +3, +4, +4, +6, or +7.

2. The method of claim 1, wherein the MSBP is hydrophilic.

3. The method of claim 1, wherein the MSBP (i) contains local regions having a positive electrostatic potential or positive charge, (ii) has an overall positive charge, or (iii) a combination thereof.

4. The method of claim 1, wherein the frozen composition comprises ice, optionally amorphous ice, cubic ice, hexagonal ice, or any combination thereof.

5. The method of claim 1, wherein the frozen composition flash-frozen in a cryogenic fluid prior to imaging.

6. The method of claim 1, further comprising processing the image to generate a structural model of the sample.

7. The method of claim 1, wherein imaging is performed using single-particle cryo-electron microscopy.

8. The method of claim 1, wherein imaging is performed using cryo-electron tomography.

9. The method of claim 1, wherein the sample comprises biomacromolecules, helical fiber complexes, virus particles, virus-like particles, bacteria, cells, tissues, organs, or any combination thereof.

10. The method of claim 1, wherein the sample comprises proteins, optionally, single protein molecules, large protein complexes, membrane proteins, nucleoprotein complexes, or thin-protein crystals.

11. The method of claim 1, wherein the metal is bonded to one or more other components of the MSBP via dative bonds and the metal is positively charged and the MSBP has an overall positive charge.

12. The method of claim 1, wherein the MSBP comprises a hydrophilic polymer segment.

13. The method of claim 1, wherein the MSBP comprises a structure: 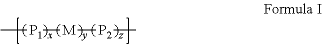
wherein:
x, y, and z are independently integers from 1 to 1,000, 1 to 500, 1 to 100, 1 to 50, or 1 to 10,
P₁, M, and P₂ are independently: 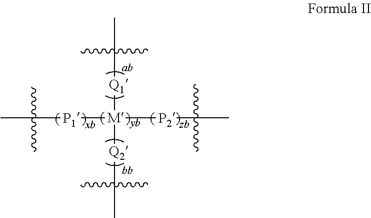
wherein:
xb and zb are independently integers from 0 to 1,000, with the proviso that xb+zb is at least 1,
yb is independently an integer from 1 to 1,000, ab and bb are independently integers from 0 to 1,000, with the proviso that ab+bb is at least 1, in at least one of P₁, M, and P₂,
P₁′, P₂′, Q₁′, and Q₂′ are independently a polymer segment, polymer segment-Lig, Lig-polymer segment-Lig′, a group 2 metal, a group 13 metal, a group 14 metal, a group 15 metal, a transition metal, wherein Lig and Lig′ are independently a monodentate ligand or multi-dentate ligand,
each M′ is independently a metal with an oxidation state of 0, +1, +2, +3, +4, +4, +6, or +7,
with the proviso that the MSBP contains a structure:
polymer segment [symbol] Lig [symbol] M′ [symbol] Lig′ [symbol] polymer segment
optionally, wherein the polymer segment comprises a hydrophilic polymer segment.

14. The method of claim 13, wherein Lig and Lig′ independently comprise one or more chelating chemical groups.

15. The method of claim 13, wherein Lig and Lig′ are independently formed from (3,5-di(pyridin-4-yl)phenyl)methanol, ethylenediamine, diethylenetriamine, ethylenediaminetetraacetate, bipyridyl, terpyridyl, 1,2-bis(dimethylphosphino)ethane, bis(diphenylphosphino)ethane, acetate, acetylacetonate, polycarboxylic acids meso-2,3-dimercaptosuccinic acid, or any combination thereof.

16. The method of claim 13, wherein Lig and Lig′ are formed from (3,5-di(pyridin-4-yl)phenyl)methanol.

17. The method of claim 13, wherein Lig and Lig′ independently comprise (3,5-di(pyridin-4-yl)phenyl)methyl.

18. The method of claim 1, wherein the MSBP comprises at least one polymer segment, wherein the at least one polymer segment is a polyalkylene glycol or a polyalkylene oxide, optionally, polyethylene glycol (PEG); a polysaccharide selected from celluloses, alginates, glucosaminoglycans, and dextrans; a hydrophilic polypeptide or a poly(amino acids), optionally poly-L-glutamic acid, gamma-polyglutamic acid, poly-L-aspartic acid, or poly-L-serine; poly(oxyethylated polyol); a poly(olefinic alcohol), optionally poly(vinyl alcohol) or aminoacetalized poly(vinyl alcohol); poly(N-vinylpyrrolidone); an acrylic acrylate, alkacrylic or alkacrylate polymer, optionally poly(acrylic acid), poly(methacrylic acid), poly(hydroxyethyl acrylate); a poly(N,N-dimethylaminoethyl methacrylate) or a poly(hydroxyalkyl methacrylate), optionally, poly(hydroxyethyl methacrylate); a acrylamide polymer, optionally, a poly(acrylamide), or a poly(hydroxyalkyl methacrylamide), optionally poly(hydroxyethyl methacrylamide; poly(4-vinylpyridine); or copolymers thereof.

19. The method of claim 1, wherein the MSBP comprises at least one polymer segment, wherein the at least one polymer segment comprises a neutral hydrophilic polymer, optionally, a neutral uncharged hydrophilic polymer.

20. The method of claim 1, wherein the MSBP comprises at least one polymer segment, wherein the at least one polymer segment comprises a polyalkylene glycol or a polyalkylene oxide, optionally PEG.

21. The method of claim 1, wherein the MSBP is formed by reacting:
Lig [symbol] PEG [symbol] Lig′
with a salt of the metal.

22. The method of claim 21, wherein Lig-PEG-Lig′ has a structure: 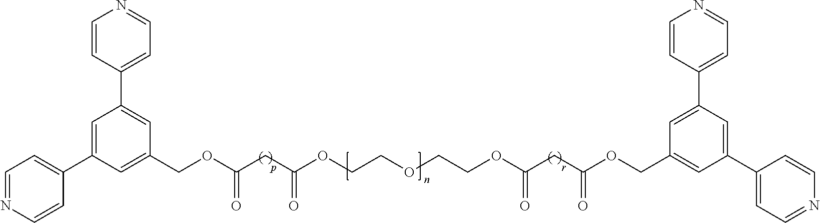
p and r are independently integers from 1 to 10, and
n is an integer from 1 to 1,000, optionally such that the PEG has a molecular weight of between about 1 kDa and about 10 kDa, between about 2.5 kDa and about 7.5 kDa or about 5 kDa.

23. A composition comprising a sample, optionally a biological sample, and an MSBP,
wherein the MSBP comprises a structure: 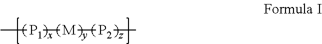
wherein:
x, y, and z are independently integers from 1 to 1,000, 1 to 500, 1 to 100, 1 to 50, or 1 to 10,
P₁, M, and P₂ are independently: 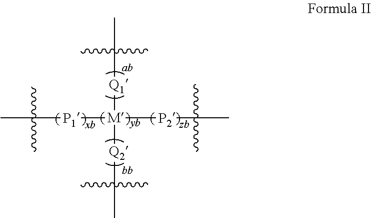
wherein:
xb and zb are independently integers from 0 to 1,000, with the proviso that xb+zb is at least 1,
yb is independently an integer from 1 to 1,000, ab and bb are independently integers from 0 to 1,000, with the proviso that ab+bb is at least 1, in at least one of P₁, M, and P₂,
P₁′, P₂′, Q₁′, and Q₂′ are independently a polymer segment, polymer segment-Lig, Lig-polymer segment-Lig′, a group 2 metal, a group 13 metal, a group 14 metal, a group 15 metal, a transition metal, wherein Lig and Lig′ are independently a monodentate ligand or multi-dentate ligand,
each M′ is independently a metal with an oxidation state of 0, +1, +2, +3, +4, +4, +6, or +7, optionally a group 10 metal, optionally having an oxidation state of +2,
with the proviso that the MSBP comprises a structure:
polymer segment [symbol] Lig [symbol] M′ [symbol] Lig′ [symbol] polymer segment
optionally, wherein at least one polymer segment comprises a neutral hydrophilic polymer segment, optionally, a neutral uncharged hydrophilic polymer.

24. The composition of claim 23, wherein Lig and Lig′ independently comprise one or more chelating chemical groups.

25. The composition of claim 23, wherein at least one polymer segments of the MSBP comprise a polyalkylene glycol or a polyalkylene oxide, optionally PEG.

26. The composition of claim 23, wherein the MSBP is formed by reacting:
Lig [symbol] PEG [symbol] Lig′
with a salt of the metal.

27. The composition of claim 26, wherein Lig-PEG-Lig′ has a structure: 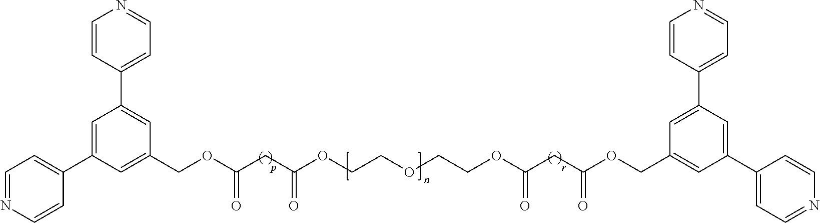
wherein:
p and r are independently integers from 1 to 10, and
n is an integer from 1 to 1,000, such that the PEG has a molecular weight of between about 1 kDa and about 10 kDa, between about 2.5 kDa and about 7.5 kDa or about 5 kDa.

28. The composition of claim 23, wherein Lig and Lig′ are independently formed from (3,5-di(pyridin-4-yl)phenyl)methanol, ethylenediamine, diethylenetriamine, ethylenediaminetetraacetate, bipyridyl, terpyridyl, 1,2-bis(dimethylphosphino)ethane, bis(diphenylphosphino)ethane, acetate, acetylacetonate, polycarboxylic acids, meso-2,3-dimercaptosuccinic acid, or any combination thereof.

29. The composition of claim 23, wherein Lig and Lig′ are formed from (3,5-di(pyridin-4-yl)phenyl)methanol.

30. The composition of claim 23, wherein Lig and Lig′ independently comprise (3,5-di(pyridin-4-yl)phenyl)methyl.

31. The composition of claim 23, wherein the MSBP (i) contains local regions having a positive electrostatic potential or positive charge, (ii) has an overall positive charge, or (iii) a combination thereof, optionally, the MSBP has an overall positive charge.

32. The composition of claim 23, wherein the composition comprises ice, optionally, amorphous ice, cubic ice, hexagonal ice, or any combination thereof.

33. The composition of claim 23, wherein the sample comprises biomacromolecules, helical fiber complexes, virus particles, virus-like particles, bacteria, cells, tissues, organs, or any combination thereof.

34. The composition of claim 23, wherein the sample comprises proteins, optionally, single protein molecules, large protein complexes, membrane proteins, nucleoprotein complexes, or thin-protein crystals.

35. The composition of claim 23, wherein the metal is bonded to Lig and/or Lig′ via dative bonds.

36. The method of claim 13, wherein each M′ is independently a group 10 metal having an oxidation state of +2.

37. The composition of claim 23, wherein each M′ is independently a group 10 metal having an oxidation state of +2.
